(19) United States
(12) Patent Application Publication
(10) Pub. No.: US 2003/0111532 A1
(43) Pub. Date: Jun. 19, 2003

(54) Self-referencing system for light gauge images

(75) Inventor: Kirby Gannett Vosburgh, Boston, MA (US)

Correspondence Address: Patrick R. Scanlon, Esq., Pierce Atwood, One Monument Square, Portland, ME, 04101, US

(73) Assignee: General Electric Company

(21) Appl. No.: 10/016,938

(22) Filed: Dec. 14, 2001

(51) Int. Cl. G06K 7/14

(52) U.S. Cl. 235/454

(57) ABSTRACT

A method and related structure for self-referencing a fabricated structure subject to light-gauge imaging. The method includes the introduction of an identifying marker applied to the exterior surface of a structure to be mapped. The marker is established with sufficient offset from the structure's surface to ensure that it is incorporated into a map image of the structure. The identifying marker travels at all times with the structure as well as with the searchable mapped image. As a result, the structure may be accurately tracked throughout its manufactured and service life.

### BACKGROUND OF THE INVENTION

This invention relates generally to systems and methods for identifying manufactured parts and more particularly to a system and a method for applying surface deformation identifiers detectable by light gauge systems.

Mechanical systems such as turbines are fabricated of many parts. In order to maximize the efficiency and effectiveness of complex mechanical systems, it is important that the component parts be fabricated as close to specification as is reasonably possible. Inspection systems including measurement gauges are employed to evaluate the accuracy of the part manufacturing process. For parts of relatively complex and varied shape, such as turbine blades, basic physical measurement tools are inadequate. For that reason, more sophisticated measurement systems are required to determine shape accuracy. One such measurement system is a light gauge.

A light gauge includes light transmitting and light detecting devices. The light transmitting devices transmit light at a selectable frequency onto the surface of a part to be inspected. The light is reflected off the surface of the part and the detecting devices pick up the reflected image. The light signals that mirror the reflected image are converted into electrical signals, preferably digital electrical signals. The electrical signals are analyzed and used to generate a map or visual image of the part in a computer file. That computer file is used to make an accurate assessment of the specific configuration of the mapped part.

The mapped image may be compared with known image values of an idealized corresponding part to evaluate manufacturing deviations. The part may then be accepted for use in service, returned for manufacturing modification, or scrapped. Alternatively or additionally, the mapped image may be stored as a record of the actual configuration of the part. That stored image may later be accessed to compare the part as first manufactured with the configuration of the part after some service period. Based on that subsequent contour evaluation, the part may be placed back in service with no lost time to maintenance, it may be taken out of service for maintenance, or it may be scrapped.

Light gauge systems are particularly effective because they are very accurate. The light transmission and detection devices may be laser-based or light emitting diodes. Such light-based emission/detection systems are employed in many fields because they are so accurate. They are particularly useful in the field of turbine parts, which parts must be manufactured with great accuracy to ensure efficient and safe turbine operation. The light-based mapping of such parts is so accurate that they easily detect and display small deformations, including those only a few mils thick. Such defects can adversely affect turbine operation if they are in the fluid pathway.

Light gauge systems are also desirable because they are nondestructive to the part under examination. However, to date, light gauge systems have only been employed in the field of manufactured parts to map the images of such parts. They are not employed in a more general way to aid in manufacturing process characterization and improvement.

As noted, turbines are fabricated of many parts, many of which must be very accurately configured. The parts are often fabricated in various automated processes including known machining systems and techniques. The parts for an individual system may come from a variety of manufacturing sites. Some parts are earmarked for introduction into new turbines while others are used as spare replacement parts. Moreover, some parts, such as turbine blades for example, first used as original components may later be used as replacement parts.

Parts when originally manufactured may be identified through temporary references. Unfortunately, individual manufactured parts are not permanently identified. As a result, as they pass through their service lives or are retained for a period of time as replacements, their identifications do not pass with them. When used subsequently in a system, there is no present knowledge of the original mapped dimensions of the part and often no indication of the original manufacturing site. Disparate parts may then be joined together and can result in a reduction in turbine operating efficiency. Also, it can be difficult to evaluate changes in the part through service operation since the original part dimensions cannot be accessed. It would therefore be useful to have permanent identifiers applied to critical manufactured parts. Such identifiers would be located in non-critical areas and would be detectable during contour mapping of the parts.

What is needed is a system and corresponding method for permanently identifying in a self-referencing manner parts subject to light gauge imaging. What is also needed is such a system and related method that permits accurate tracking of identified parts through their service lives without effect on system operation.

### SUMMARY OF THE INVENTION

The above-mentioned needs are met by the present invention, which provides a system and method for permanently identifying manufactured parts such as turbine components. The method establishes a self-referenced structure having an exterior mappable by a light gauge system. The self-referencing is achieved by applying an identifying marker to the exterior of the structure and creating a contour map representation of the structure such that the identifying marker forms part of said map representation. The identifying marker may be applied as part of the fabrication of the part as a raised pattern. Alternatively, it may be a bar code-type label adhesively-applied to the exterior surface of the structure, preferably formed in a non-critical region of the structure.

The present invention and its advantages over the prior art will become apparent upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a perspective view of structure patterned with an identifying marker of the present invention detectable by a generic light gauge system.

FIG. 2 is a flow diagram of the method associated with obtaining a mapped representation of a structure with a mappable identifying marker of the present invention.

### DETAILED DESCRIPTION OF THE INVENTION

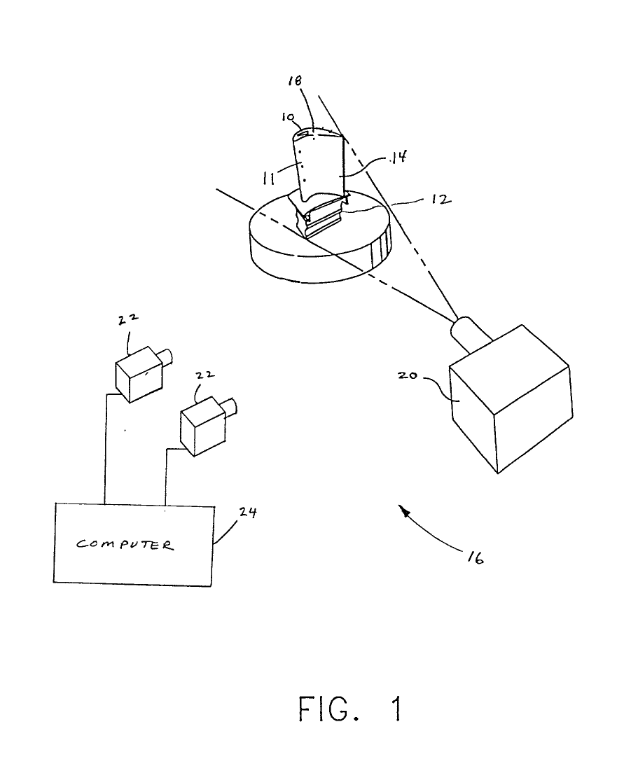

FIG. 1 illustrates a patterned marking 10 of the present invention as applied to a structure 11. For the purpose of illustration, the structure 11 in FIG. 1 is a turbine blade or bucket having a dovetail portion 12 for mounting the bucket to a rotor disk in a gas turbine engine and an airfoil portion 14 that is exposed to a hot gas flow during engine operation. However, it is to be understood that the present invention is not limited to turbine buckets and the structure 11 may be any sort of part or element for which tracking is of interest. The marking 10 is an identifying element that is formed on or applied to an exterior surface of the bucket 11 and observable by a light gauge system 16. That marking 10 may be a raised bar pattern or a bar-code type label, for example. The marking is a serial identification pattern that conforms to the identifying program of the structure supplier and/or user. The marking 10 is preferably applied to a non-critical region of the structure 11, such as the tip 18 of the airfoil portion 14 or the dovetail portion 12, that is generally out of the hot gas flow. The marking 10 is further preferably located in a region that is non-critical for measurement for part acceptance.

The patterned marking 10 may be applied in any way that is compatible with the process associated with making the structure 11. It may be incorporated into the fabrication process as a raised patterned. Alternatively, it may simply be attached, such as by suitable adhesive, as a coded label to the structure 11. Subsequent light imaging of the structure 11 by the light gauge system 16 establishes a mapped representation of the structure 11. This imaging process may be the same type of imaging process currently employed to create a structure contour map. In one possible embodiment, the light gauge system 16 includes an illumination source 20 and at least two cameras 22. The illumination source 20, which is typically a laser, is arranged to direct patterned illumination onto the structure 11. The cameras 22 are located at an oblique angle to detect illumination reflected from the structure 11. The digital output of the cameras 22 is fed to a computer 24 that uses the output to generate a mapped representation of the structure 11. A light gauge system of this type is described in more detail in U.S. Pat. No. 5,589,942 issued Dec. 31, 1996 to Steven J. Gordon. However, it is noted that the present invention is not limited to this particular light gauge system and can be used with a wide variety of light gauge systems.

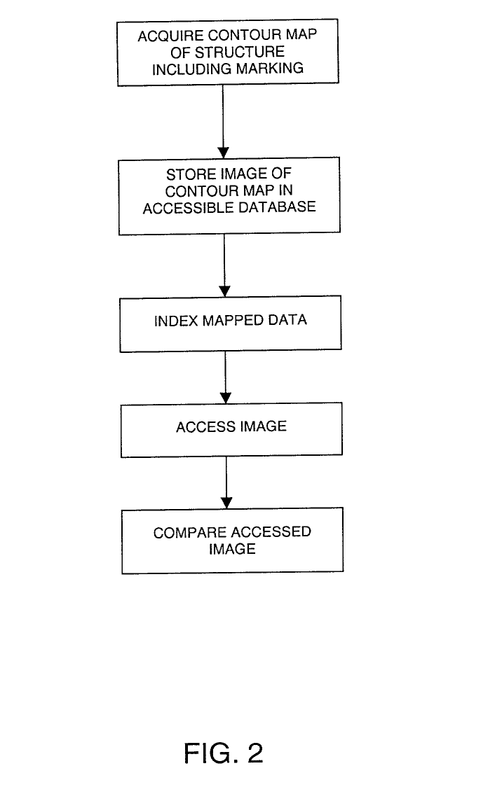

As summarized in FIG. 2, the mapped representation is stored as a digital representation of the structure 11. The marking 10 is automatically incorporated into the stored image. As a result, a user, such as a computer device or a human operator, may observe the marking 10 in association with the structure 11. The image file may be accurately indexed as part of a comprehensive searchable database. The mapped representation of the self-referenced structure 11 with marking 10 can be accessed by accessing the database. The accessed image may be used to track the structure 11 through manufacturing as well as through its service life.

The foregoing has described a system and method for identifying a structure as part of an imaging procedure. While a specific embodiment of the present invention has been described, it will be apparent to those skilled in the art that various modifications thereto can be made without departing from the spirit and scope of the invention as defined in the appended claims.

What is claimed is:

1. A method of self-referencing a structure having an exterior mappable by a light gauge system, the method comprising the steps of:
applying an identifying marker to the exterior of the structure; and
creating a contour map representation of the structure such that said identifying marker forms part of said map representation.

2. The method of claim 1 further comprising the step of:
indexing said contour map representation of the structure with said identifying marker in a searchable database.

3. The method of claim 1 wherein said identifying marker is established as a raised pattern on the exterior surface of the structure.

4. The method of claim 3 wherein said raised pattern is formed by machining the exterior surface of the structure to create said identifying marker.

5. The method of claim 1 wherein said identifying marker is established as a bar-code label adhesively applied to the exterior surface of the structure.

6. The method of claim 1 wherein said identifying marker is a serial pattern uniquely associated with the structure.

7. The method of claim 1 further comprising the step of tracking the fabrication or service life of the structure using said identifying marker.

8. An identified structure comprising an exterior surface, wherein the exterior surface includes an identifying marker readable by a light gauge system.

9. The structure of claim 8 wherein said identifying marker is a raised serial pattern machined into the exterior surface of the structure.

10. The structure of claim 8 wherein said identifying marker is a coded label adhesively applied to the exterior surface of the structure.

11. The structure of claim 8 wherein the structure is a turbine bucket.

12. The structure of claim 8 wherein said identifying marker forms a part of a mapped and searchable computer-based representation of the structure.

13. The structure of claim 8 wherein said identifying marker is applied to a region of the exterior surface that is not critical for measurement of acceptance of the structure.
